(19) United States
(12) Patent Application Publication
(10) Pub. No.: US 2012/0308047 A1
(43) Pub. Date: Dec. 6, 2012

(54) SELF-TUNING MEMS MICROPHONE

(75) Inventor: John M. Muza, Venetia, PA (US)

(73) Assignee: Robert Bosch GmbH, Stuttgart (DE)

(21) Appl. No.: 13/150,293

(22) Filed: Jun. 1, 2011

(51) Int. Cl. H04R 3/00

(52) U.S. Cl. 381/111

(57) ABSTRACT

A self-tuning MEMS microphone. The microphone includes a capacitive sensor, an amplifier, a signal converter, a frequency generator, a micro-speaker, and a controller. The capacitive sensor is configured to detected a sound wave and output an electric signal based on the sound wave. The amplifier is coupled to the capacitive sensor, and configured to amplify the electric signal. The signal converter is coupled to the amplifier, and configured to adjust a frequency response of the amplified electric signal. The frequency generator is configured to output an AC electric signal. The micro-speaker is coupled to the frequency generator, and configured to convert the AC electric signal into a sound wave. The controller is coupled to the signal converter and the frequency generator. The controller is configured to direct the frequency generator to output the AC electric signal at a predetermined frequency and to detect an amplified electric signal generated by the capacitive sensor based on the AC electric signal.

### BACKGROUND

The invention relates to a MEMS microphone, specifically, a MEMS microphone that self-tunes on power-up for flat response over the entire frequency range of the microphone.

FIG. 1 shows a typical frequency response curve for a microphone. Below 50 Hz and around 18 kHz, the frequency response deviates from a flat response (i.e., 0 dB). Venting or leaking through a diaphragm or membrane causes low-frequency roll off, while high-frequency peaking is caused by system resonances (e.g., microphone and packaging mechanics) and other acoustic parameters.

### SUMMARY

In one embodiment, the invention provides a self-tuning MEMS microphone. The microphone includes a capacitive sensor, an amplifier, a signal converter, a frequency generator, a micro-speaker, and a controller. The capacitive sensor is configured to detected a sound wave and output an electric signal based on the sound wave. The amplifier is coupled to the capacitive sensor, and configured to amplify the electric signal. The signal converter is coupled to the amplifier, and configured to adjust a frequency response of the amplified electric signal. The frequency generator is configured to output an AC electric signal. The micro-speaker is coupled to the frequency generator, and configured to convert the AC electric signal into a sound wave. The controller is coupled to the signal converter and the frequency generator. The controller is configured to direct the frequency generator to output the AC electric signal at a predetermined frequency and to detect an amplified electric signal generated by the capacitive sensor based on the AC electric signal.

In another embodiment the invention provides a method of tuning a MEMS microphone. The method includes outputting a plurality of sound waves having varying frequencies from a micro-speaker of the MEMS microphone, detecting the output sound waves, converting the sound waves into electrical signals, storing a parameter for each of the electrical signals, determining at which frequencies the parameter varies from an expected magnitude, and correcting an output of the MEMS microphone for the frequencies where the parameter varied.

Other aspects of the invention will become apparent by consideration of the detailed description and accompanying drawings.

### BRIEF DESCRIPTION OF THE DRAWINGS

FIG. 1 is a graph of a frequency response of a typical MEMS microphone.

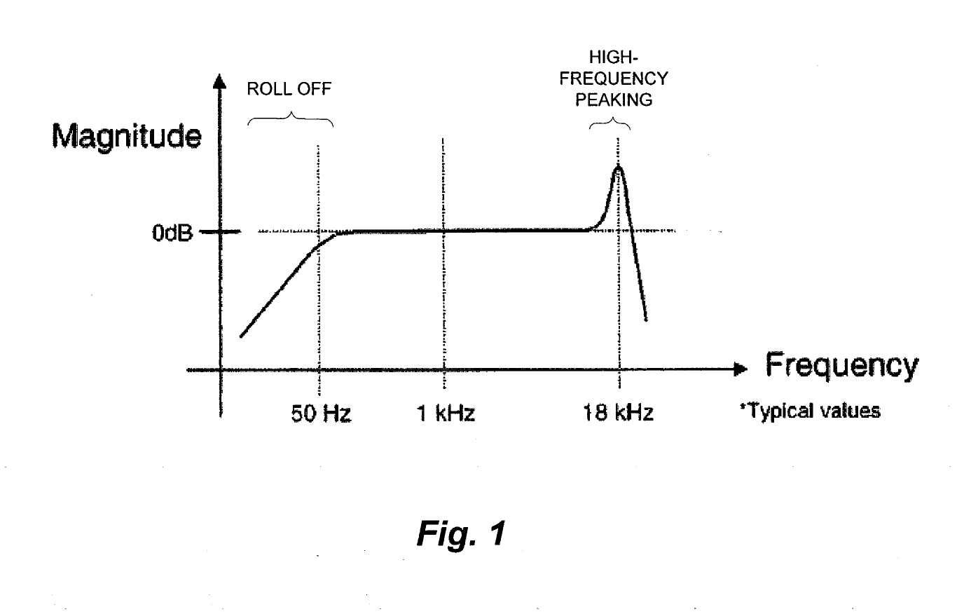

FIG. 2 is a schematic/block diagram of a self-tuning MEMS microphone.

FIG. 3 is a flow chart of an operation of the self-tuning MEMS microphone of FIG. 2.

FIG. 4 is a graph of a frequency response of the MEMS microphone of FIG. 2.

FIG. 5 is a schematic/block diagram of a dual-capacitive sensor, self-tuning MEMS microphone for use in high-noise environments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The invention is a self-tuning MEMS microphone which tunes itself each time it is turned on or powered-up to provide a flat frequency response over the entire audible frequency range (e.g., 20 Hz to 20 kHz). This simplifies design and manufacturing of devices incorporating MEMS microphones by compensating for the effects of enclosures and environments on the frequency response of the microphone.

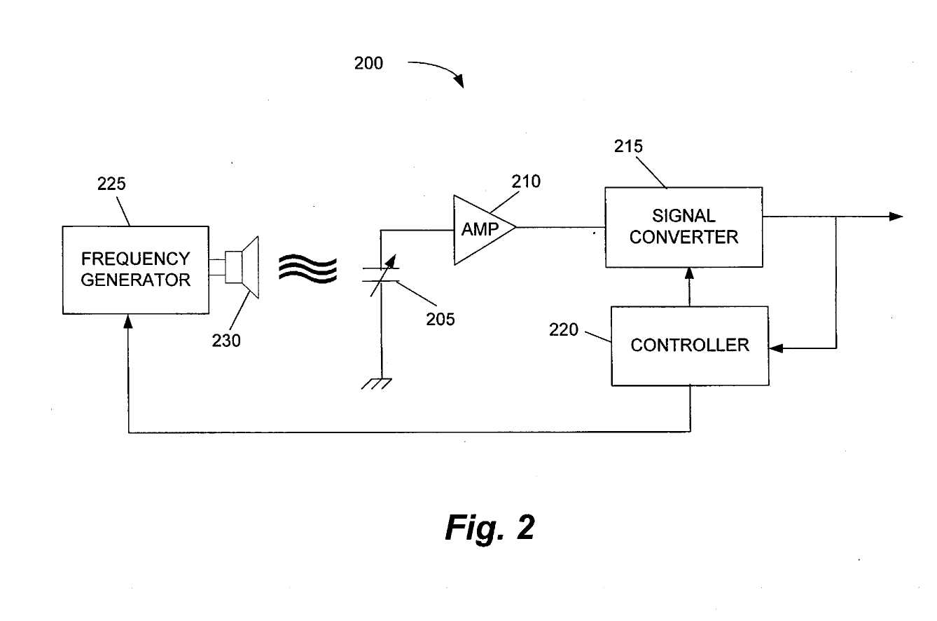

FIG. 2 shows a schematic/block diagram of a self-tuning MEMS microphone 200. The microphone 200 includes a capacitive sensor 205 (the component that senses sound waves), an amplifier 210, a signal converter 215, a controller 220, a frequency generator 225, and a micro-speaker 230.

The controller 220 controls the operation of the frequency generator 225 and the signal converter 215. The controller 220 also monitors the output of the signal converter 215, and, during a tuning process, stores parameters of the microphone 200. The controller 220 can include a processor and memory and/or could include discrete components such as one or more shift registers. The frequency generator 225 is configured to output a sinusoidal electric signal to the micro-speaker 230.

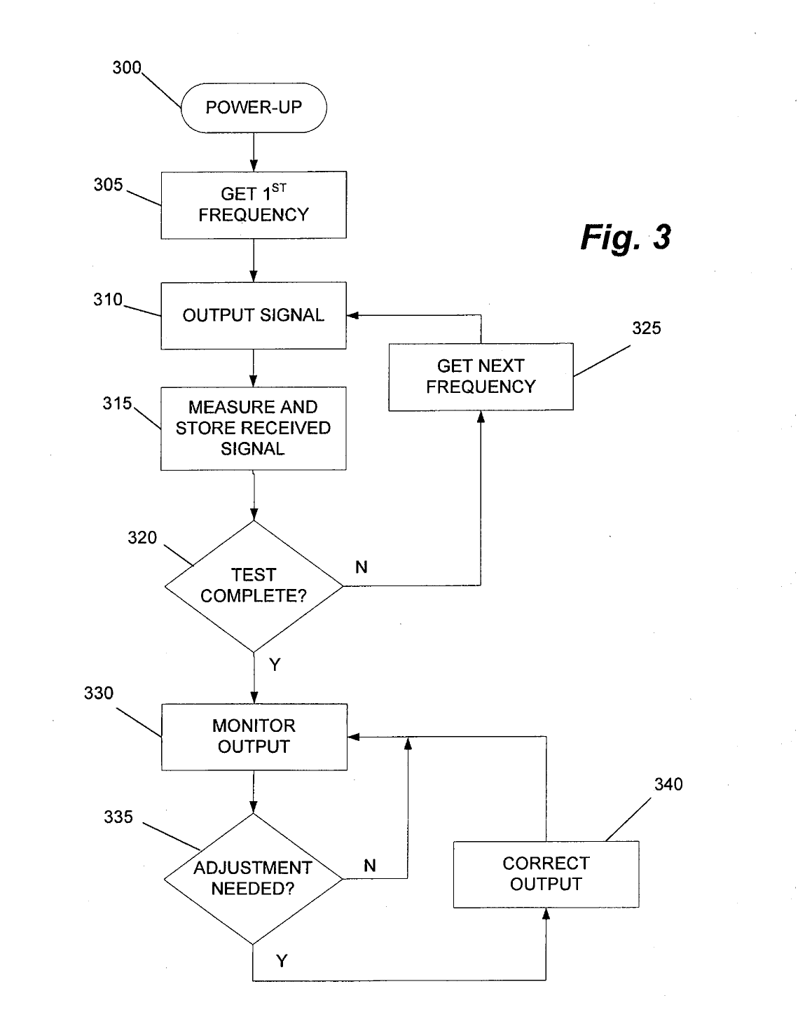

FIG. 3 shows an exemplary operation of the microphone 200 of FIG. 2. Upon power-up, the microphone 200 is turned on (step 300), the controller 220 selects a first frequency for the frequency generator 225 to output (step 305). The frequency generator 225 outputs a signal having the selected frequency to the micro-speaker 230 (step 310) causing the micro-speaker 230 to produce a sound wave having the selected frequency. The sound wave is detected by the capacitive sensor 205. The sensor 205 converts the sound wave into an electrical signal which is amplified by the amplifier 210 and converted by the signal converter 215. The controller 220 measures the converted electrical signal, and stores the measured value (i.e., a parameter) along with the frequency (step 315) (or in a position designated for the frequency).

Next, the controller 220 determines if the test is complete (step 320). If the test is not complete, the controller 220 selects another frequency (e.g., 1 kHz greater than the previous frequency) (step 325), and repeats the process from step 310 (outputting a signal having the selected frequency).

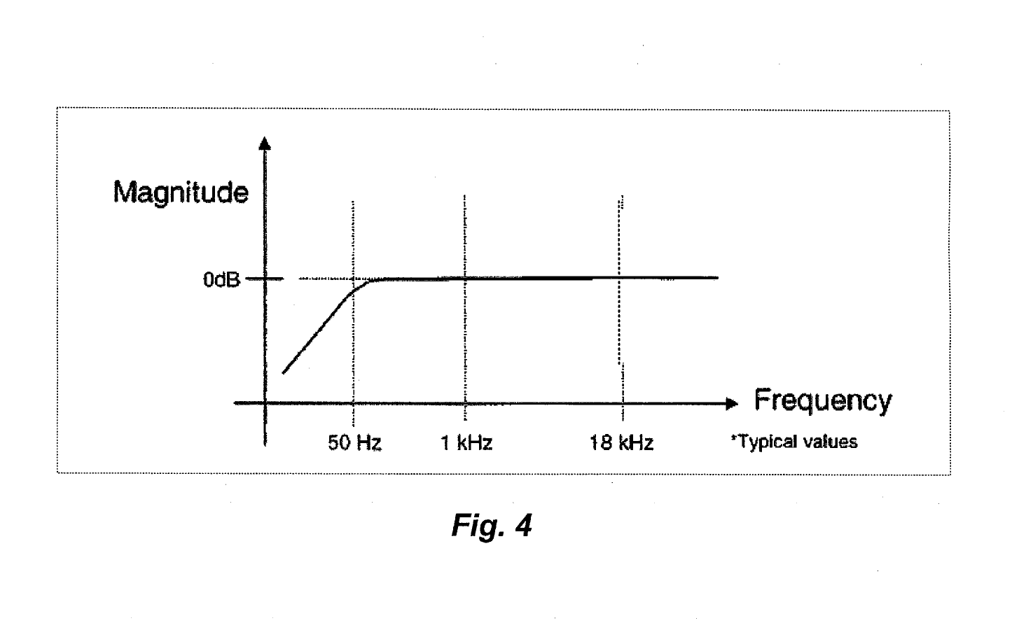

Once the test is complete (step 320) (e.g., after reaching 20 kHz), the controller 220 determines where the frequency response of the microphone 200 deviates from an expected response, and determines what modifications should be made to correct the frequency response of the microphone. The controller 220 begins by monitoring the output of the microphone 200 (step 330). The controller 220 determines whether the microphone 200 is picking up a sound wave having a frequency that needs correcting (step 335). If a correction is needed, the controller 220 adjusts the output signal of the microphone 200 to correct the frequency response (step 340), and continues monitoring the microphone 200 (step 330). Thus, the microphone 200 outputs a corrected signal having a flat frequency response as shown in FIG. 4.

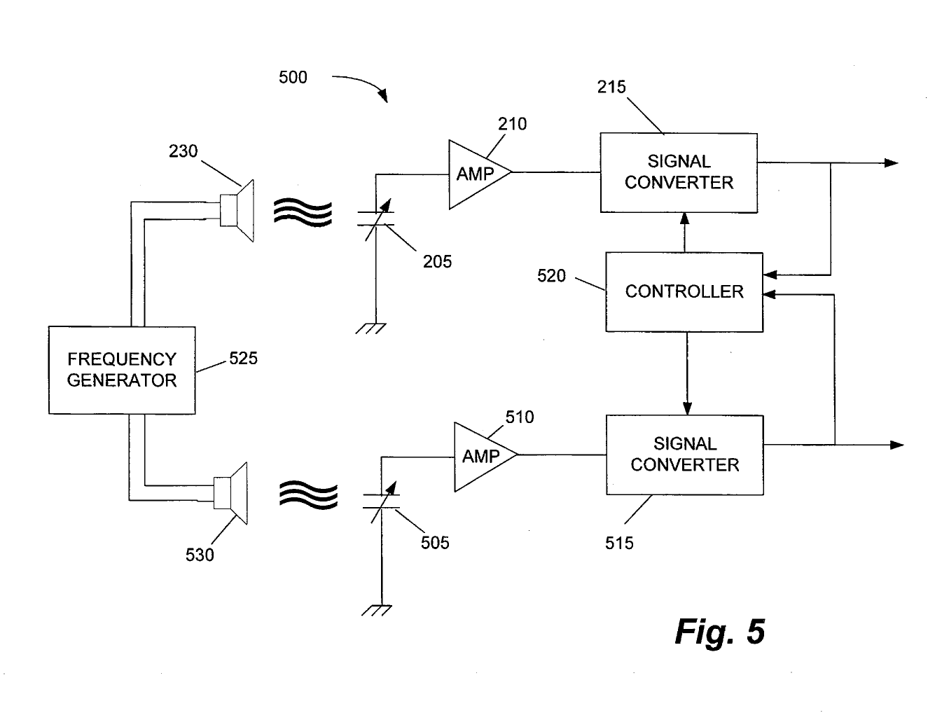

FIG. 5 shows an alternative construction of a self-tuning MEMS microphone 500 that is able to tune itself in a noisy environment. In addition to the components of microphone 200, the microphone 500 includes a second capacitive sensor 505, a second amplifier 510, a second signal converter 515, and a second micro-speaker 530. A controller 520 controls all of the components of the microphone 500, and a frequency generator 525 drives both micro-speakers 230 and 530. The components of the microphone 500 are positioned such that the capacitive sensor 205 does not pick up sound from the second micro-speaker 530, and the second capacitive sensor 505 does not pick up sound from the micro-speaker 230. However, both capacitive sensors 205 and 505 pick up sounds external to the microphone 500.

During power-up, each of the capacitive sensors 205 and 505 are tuned separately (i.e., at different times). During the tuning of the capacitive sensor 205, the capacitive sensor 205 and the second capacitive sensor 505 are picking up sounds external to the microphone 500. The capacitive sensor 205 is also picking up the sound emitted by the micro-speaker 230. The controller 520 uses the sound picked up by the second capacitive sensor 505 to remove a component of the signal generated by the capacitive sensor 205 that is caused by the external sounds, leaving behind a signal representative of the sound emitted by the micro-speaker 230. The controller 520 then uses this modified sound signal (i.e., the signal reflective of the sound output by the micro-speaker 230) to tune the capacitive sensor 205 as described above.

Similarly, the controller 520 uses external sounds picked up by the capacitive sensor 205 to remove a component of the signal generated by the capacitive sensor 505 that is caused by the external sounds, leaving behind a signal representative of the sound emitted by the micro-speaker 530. The controller 520 then uses this modified sound signal (i.e., the signal reflective of the sound output by the micro-speaker 530) to tune the capacitive sensor 505 as described above.

Various features and advantages of the invention are set forth in the following claims.

What is claimed is:

1. A self-tuning MEMS microphone, the microphone comprising:
a capacitive sensor configured to detected a sound wave and output an electric signal based on the sound wave;
an amplifier coupled to the capacitive sensor, and configured to amplify the electric signal;
a signal converter coupled to the amplifier, and configured to adjust a frequency response of the amplified electric signal;
a frequency generator configured to output an AC electric signal;
a micro-speaker coupled to the frequency generator, and configured to convert the AC electric signal into a sound wave; and
a controller coupled to the signal converter and the frequency generator, the controller configured to direct the frequency generator to output the AC electric signal at a predetermined frequency and to detect an amplified electric signal generated by the capacitive sensor based on the AC electric signal.

2. The microphone of claim 1, wherein the controller directs the frequency generator to output the AC electric signal at a plurality of predetermined frequencies.

3. The microphone of claim 2, wherein the controller stores a parameter indicative of the amplified electric signal for each of the predetermined frequencies.

4. The microphone of claim 3, wherein the controller determines at which of the plurality of predetermined frequencies the parameter varies from an expected value.

5. The microphone of claim 1, wherein the controller directs the signal converter to correct the amplified electric signal when the amplified electric signal has a frequency determined to require adjusting.

6. A method of tuning a MEMS microphone, the method comprising:
outputting a plurality of sound waves having varying frequencies from a micro-speaker of the MEMS microphone;
detecting the output sound waves;
converting the sound waves into electrical signals;
storing a parameter for each of the electrical signals;
determining at which frequencies the parameter varies from an expected magnitude; and
correcting an output of the MEMS microphone for the frequencies where the parameter varied.

7. The method of claim 6, wherein a frequency generator outputs a plurality of sinusoidal electric signals at predetermined frequencies, the sinusoidal electric signals causing the micro-speaker to output the plurality of sound waves.

8. The method of claim 6, wherein the method is performed each time the MEMS microphone is powered-up.

9. The method of claim 6, further comprising amplifying the electric signals.

10. The method of claim 6, wherein a signal converter corrects the electric signals when the electric signals have a frequency determined to require adjusting.
